(19) United States
(12) Patent Application Publication
(10) Pub. No.: US 2026/0229823 A1
(43) Pub. Date: Aug. 6, 2026

(54) SYSTEMS AND METHODS FOR PREVENTING DAMAGE DURING INSERTION OF INFORMATION HANDLING RESOURCE BY RESTRICTING ACCESS BETWEEN ADJACENT RECEPTACLE CONNECTORS

(71) Applicant: Dell Products L.P., Round Rock, TX (US)

(72) Inventors: Larry ROBISON, Austin, TX (US); Bernard H. FET, Pflugerville, TX (US); Michael LO, Round Rock, TX (US)

(73) Assignee: Dell Products L.P., Round Rock, TX (US)

(21) Appl. No.: 19/043,691

(22) Filed: Feb. 3, 2025

(51) Int. Cl. H01R 13/645; H01R 12/72; H01R 12/73

(52) U.S. Cl. CPC H01R 13/6456; H01R 12/721; H01R 12/737

(57) ABSTRACT

An information handling system may include a circuit board, a plurality of receptacle connectors electrically coupled to and mechanically mounted upon the circuit board, and a blocking feature located between a pair of adjacent receptacle connectors of the plurality of receptacle connectors and creating a mechanical interference that prevents insertion of an information handling resource into an empty volume of space between the pair of adjacent receptacle connectors.

### TECHNICAL FIELD

The present disclosure relates in general to information handling systems, and more particularly to preventing damage during insertion of an information handling resource, such as a memory module, into a receptable connector by restricting access between adjacent receptacle connectors.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may often use one or more circuit boards. A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

A type of circuit board often used in information handling systems is a memory module, such as a dual-inline memory module (DIMM). DIMMs typically comprise a circuit board with a plurality of memory chips mounted thereon. A DIMM may include an edge connector on an edge of the circuit board used to implement the DIMM, the edge connector configured to mechanically and electrically couple to a receptacle connector, which may also be referred to as a socket.

To accommodate receipt of multiple memory modules in an information handling system, the information handling system may include a plurality of closely-spaced receptacle connectors. However, in many implementations, a volume of empty space may exist between adjacent receptacle connectors. The existence of such volume of empty space presents a risk of accidental installation of a memory module into this volume of empty space, which could potentially damage the memory module or one or both of the adjacent receptacle connectors. Accordingly, systems and methods may be desired to mitigate or eliminate such risk.

### SUMMARY

In accordance with the teachings of the present disclosure, the disadvantages and problems associated with inserting an information handling resource into a connector of an information handling system may be reduced or eliminated.

In accordance with embodiments of the present disclosure, an information handling system may include a circuit board, a plurality of receptacle connectors electrically coupled to and mechanically mounted upon the circuit board, and a blocking feature located between a pair of adjacent receptacle connectors of the plurality of receptacle connectors and creating a mechanical interference that prevents insertion of an information handling resource into an empty volume of space between the pair of adjacent receptacle connectors.

In accordance with these and other embodiments of the present disclosure, a method may include mechanically mounting a plurality of receptacle connectors upon a circuit board and locating a blocking feature between a pair of adjacent receptacle connectors of the plurality of receptacle connectors and creating a mechanical interference that prevents insertion of an information handling resource into an empty volume of space between the pair of adjacent receptacle connectors.

In accordance with these and other embodiments of the present disclosure, a receptacle connector may include mechanical features for mechanically retaining an information handling resource within the receptacle connector and a blocking feature extending from the mechanical features and configured to, when the receptacle connector is mechanically mounted to a circuit board, create a mechanical interference that prevents insertion of an information handling resource into an empty volume of space between the receptacle connector and an adjacent receptacle connector mechanically mounted to the circuit board.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2A illustrates a top-down plan view of two memory slots and blocking features configured to prevent accidental insertion of a memory module between an empty volume of space between the memory slots, in accordance with embodiments of the present disclosure;

FIG. 2B illustrates a side elevation view of the two memory slots and blocking features of FIG. 2A, in accordance with embodiments of the present disclosure;

FIG. 3A illustrates a top-down plan view of two memory slots and blocking features configured to prevent accidental insertion of a memory module between an empty volume of space between the memory slots, in accordance with embodiments of the present disclosure;

FIG. 3B illustrates a side elevation view of the two memory slots and blocking features of FIG. 3A, in accordance with embodiments of the present disclosure;

FIG. 4A illustrates a top-down plan view of three memory slots and blocking features configured to prevent accidental insertion of a memory module between an empty volume of space between adjacent memory slots of the depicted memory slots, in accordance with embodiments of the present disclosure;

FIG. 4B illustrates a side elevation view of the three adjacent memory slots and blocking features of FIG. 4A, in accordance with embodiments of the present disclosure;

FIG. 5A illustrates a top-down plan view of three memory slots and blocking features configured to prevent accidental insertion of a memory module between an empty volume of space between adjacent memory slots of the depicted memory slots, in accordance with embodiments of the present disclosure;

FIG. 5B illustrates a side elevation view of the three adjacent memory slots and blocking features of FIG. 5A, in accordance with embodiments of the present disclosure; and

FIG. 6 illustrates an isometric perspective view of a frame that may be used to implement the blocking features depicted in FIGS. 4A and 4B, in accordance with embodiments of the present disclosure.

### DETAILED DESCRIPTION

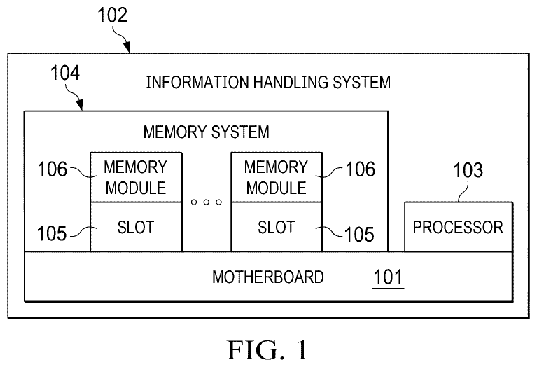

Preferred embodiments and their advantages are best understood by reference to FIGS. 1 through 6, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, buses, memories, I/O devices and/or interfaces, storage resources, network interfaces, motherboards, integrated circuit packages; electro-mechanical devices (e.g., air movers), displays, and power supplies.

For the purposes of this disclosure, circuit boards may broadly refer to printed circuit boards (PCBs), printed wiring boards (PWBs), printed wiring assemblies (PWAs), etched wiring boards, and/or any other board or similar physical structure operable to mechanically support and electrically couple electronic components (e.g., packaged integrated circuits, slot connectors, etc.). A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

FIG. 1 illustrates a block diagram of selected components of an example information handling system 102, in accordance with embodiments of the present disclosure. In some embodiments, information handling system 102 may be a personal computer. In some embodiments, information handling system 102 may comprise or be an integral part of a server. In other embodiments, information handling system 102 may be a portable information handling system (e.g., a laptop, notebook, tablet, handheld, smart phone, personal digital assistant, etc.). As shown in FIG. 1, information handling system 102 may include a motherboard 101, a processor 103 electrically and mechanically coupled to motherboard 101, and a memory system 104 electrically and mechanically coupled to motherboard 101, thus electrically coupling memory system 104 to processor 103.

Motherboard 101 may include a circuit board configured to provide structural support for one or more information handling resources of information handling system 102 and/or electrically couple one or more of such information handling resources to each other and/or to other electric or electronic components external to information handling system 102.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory system 104 and/or another component of information handling system 102.

Memory system 104 may be communicatively coupled to processor 103 and may include any system, device, or apparatus configured to retain program instructions and/or data for a period of time (e.g., computer-readable media). Memory system 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory system 104 may comprise a plurality of memory slots 105, each mechanically and electrically coupled to motherboard 101 and each configured to receive a corresponding memory module 106. A memory slot 105 may include any system, device, or apparatus configured to receive a memory module 106 in order to electrically couple such memory module 106 to processor 103. Each memory module 106 may include any system, device or apparatus configured to retain program instructions and/or data for a period of time (e.g., computer-readable media). Each memory module 106 may include a dynamic random access memory (DRAM) module (e.g, a Dual In-line Package (DIP) memory, a Single In-line Pin Package (SIPP) memory, a Single In-line Memory Module (SIMM), a Dual In-line Memory Module (DIMM), a Ball Grid Array (BGA)), or any other suitable memory.

To insert a memory module 106 into a memory slot 105, a person may need to apply force along an edge of the memory module and in a direction perpendicular to a surface of the circuit board implementing the memory module 106, in order to cause an edge connector of the memory module 106 to electrically and mechanically couple to the memory slot 105, which may be implemented as a receptacle connector. However, as described in the Background section, during such attempted insertion of a memory module 106 into a memory slot 105, the memory module 106 may be accidentally inserted into a volume of space between adjacent memory slots 105, presenting a risk of damage to such memory module 106 or adjacent memory slots 105.

In addition to motherboard 101, processor 103, and memory system 104, information handling system 102 may include one or more other information handling resources.

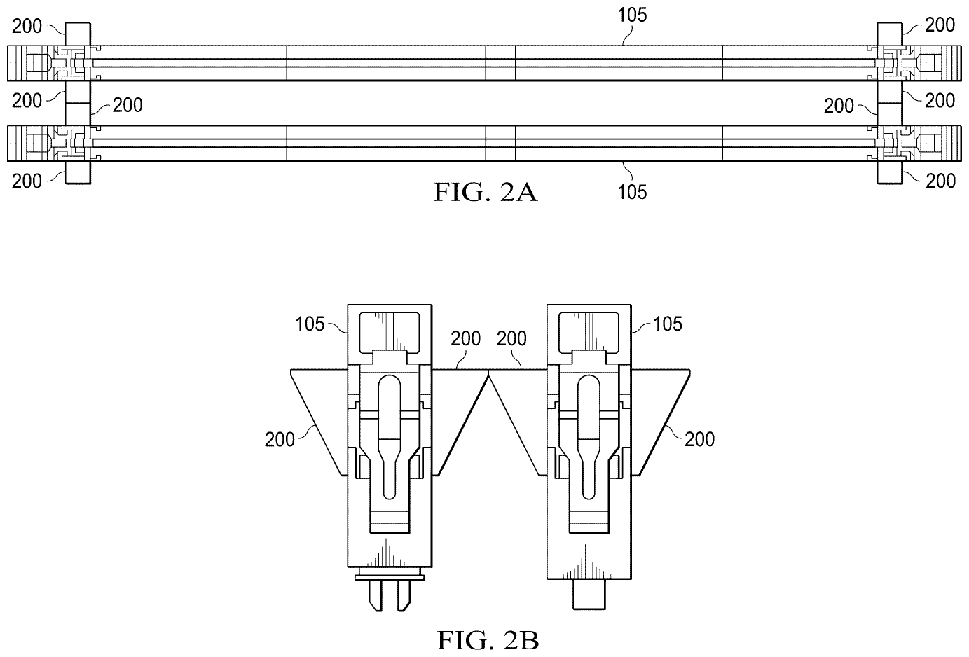

FIG. 2A illustrates a top-down plan view of two memory slots 105 and blocking features 200 configured to prevent accidental insertion of a memory module 106 between an empty volume of space between memory slots 105, in accordance with embodiments of the present disclosure. FIG. 2B illustrates a side elevation view of memory slots 105 and blocking features 200, in accordance with embodiments of the present disclosure. As shown in FIGS. 2A and 2B, blocking features 200 may be formed proximate to one or both ends of each memory slot 105 and may extend from both sides of each memory slot 105. Accordingly, blocking features 200 may physically take up at least a portion of the otherwise empty volume of space between adjacent memory slots 105, thus providing a mechanical interference feature that may prevent attempted accidental insertion of a memory module 106 into such empty volume of space. In some embodiments, blocking features 200 may be mechanically coupled (e.g., via adhesive or fastener) to their respective memory slots 105. In other embodiments, blocking features 200 may be integral to their respective memory slots 105, wherein in one or more of such embodiments, a memory slot 105 and its respective blocking feature(s) 200 may be formed as the same molded piece of material.

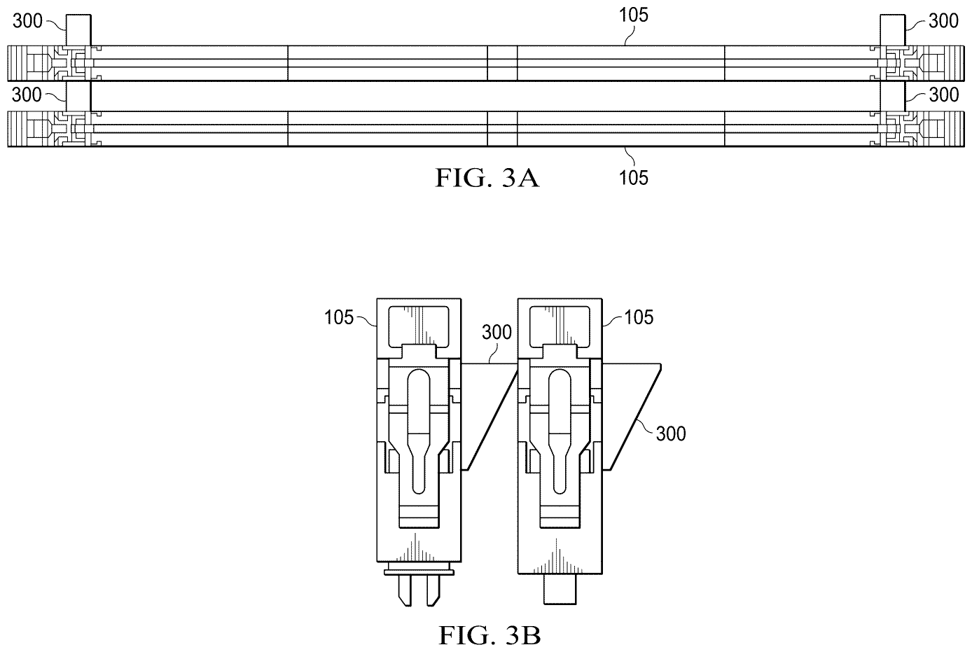

FIG. 3A illustrates a top-down plan view of two memory slots 105 and blocking features 300 configured to prevent accidental insertion of a memory module 106 between an empty volume of space between memory slots 105, in accordance with embodiments of the present disclosure. FIG. 3B illustrates a side elevation view of memory slots 105 and blocking features 300, in accordance with embodiments of the present disclosure. As shown in FIGS. 3A and 3B, blocking features 300 may be formed proximate to one or both ends of each memory slot 105 and may extend from one side of each memory slot 105. Accordingly, blocking features 300 may physically take up at least a portion of the otherwise empty volume of space between adjacent memory slots 105, thus providing a mechanical interference feature that may prevent attempted accidental insertion of a memory module 106 into such empty volume of space. In some embodiments, blocking features 300 may be mechanically coupled (e.g., via adhesive or fastener) to their respective memory slots 105. In other embodiments, blocking features 300 may be integral to their respective memory slots 105, wherein in one or more of such embodiments, a memory slot 105 and its respective blocking feature(s) 300 may be formed as the same molded piece of material.

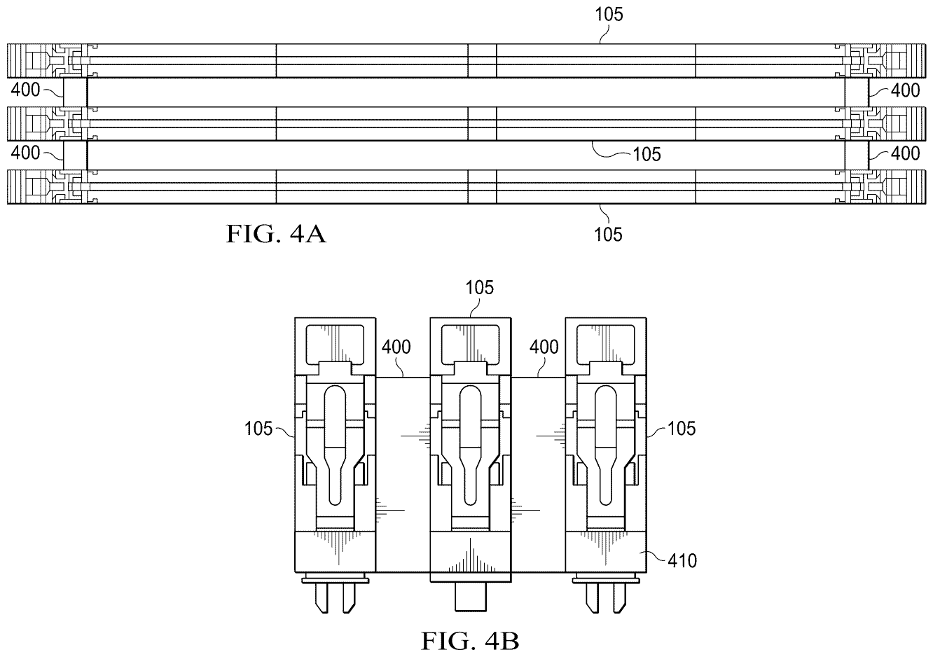

FIG. 4A illustrates a top-down plan view of three memory slots 105 and blocking features 400 configured to prevent accidental insertion of a memory module 106 between an empty volume of space between adjacent memory slots 105, in accordance with embodiments of the present disclosure. FIG. 4B illustrates a side elevation view of memory slots 105 and blocking features 400, in accordance with embodiments of the present disclosure. As shown in FIGS. 4A and 4B, a plurality of blocking features 400 may be formed as a single frame of material which may be inserted proximate to memory slots 105. Accordingly, blocking features 400 may physically take up at least a portion of the otherwise empty volume of space between adjacent memory slots 105, thus providing a mechanical interference feature that may prevent attempted accidental insertion of a memory module 106 into such empty volume of space.

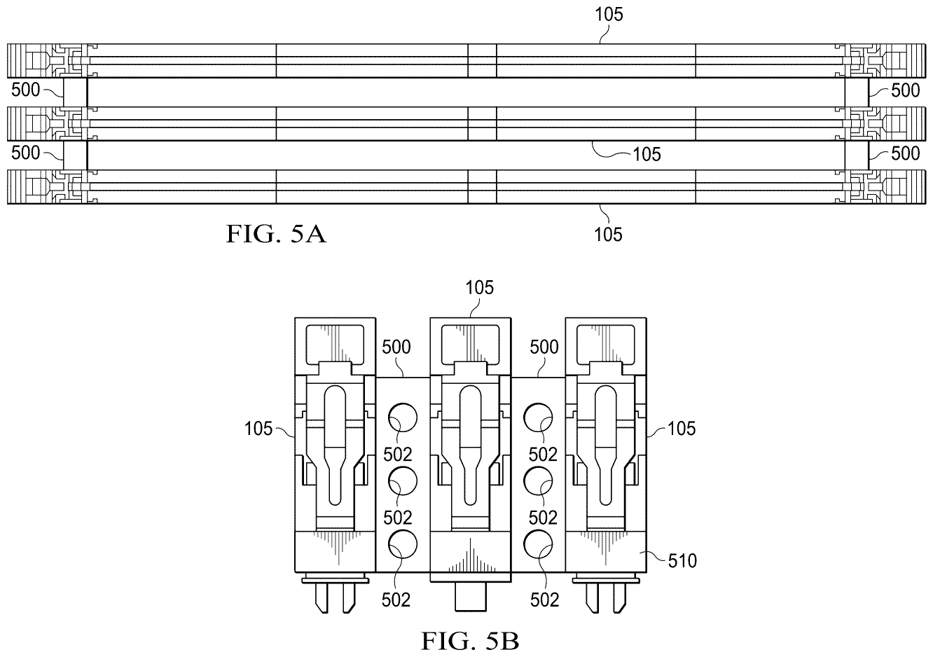

FIG. 5A illustrates a top-down plan view of three memory slots 105 and blocking features 500 configured to prevent accidental insertion of a memory module 106 between an empty volume of space between adjacent memory slots 105, in accordance with embodiments of the present disclosure. FIG. 5B illustrates a side elevation view of memory slots 105 and blocking features 500, in accordance with embodiments of the present disclosure. As shown in FIG. 5B, a plurality of blocking features 500 may be formed as a single frame of material which may be inserted proximate to memory slots 105. Accordingly, blocking features 500 may physically take up at least a portion of the otherwise empty volume of space between adjacent memory slots 105, thus providing a mechanical interference feature that may prevent attempted accidental insertion of a memory module 106 into such empty volume of space. Also as shown in FIG. 5B, blocking features 500 may include one or more passages 502 to allow airflow to flow through blocking features 500.

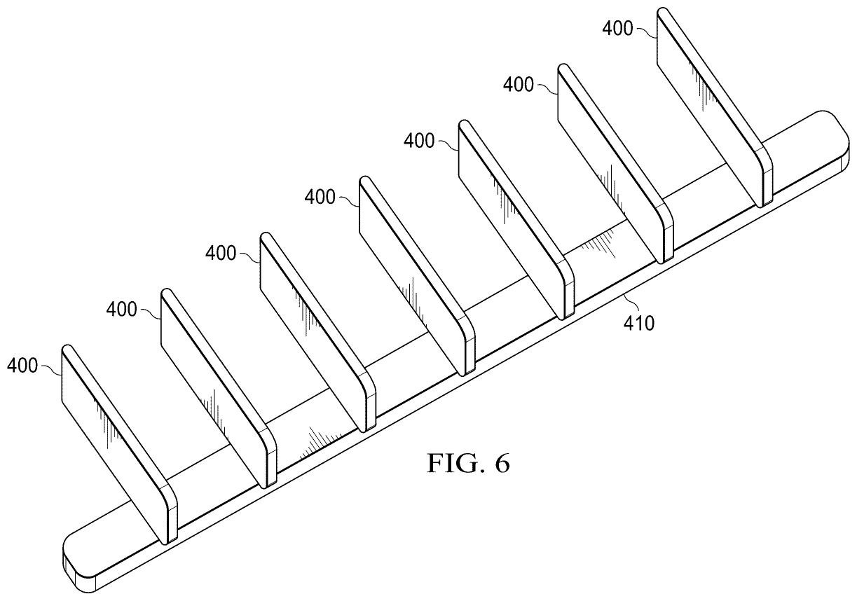

FIG. 6 illustrates an isometric perspective view of a frame 410 that may be used to implement blocking features 400, in accordance with embodiments of the present disclosure. A frame similar to frame 410, but with one or more passages 502 formed in blocking features thereof, may be used to implement frame 510 and blocking features 500.

Although the foregoing contemplates prevention of memory modules between memory slots, it is understood that systems and methods similar or identical to those described above may be applied to information handling resources other than memory modules and to receptacle connectors other than memory slots.

While the terms “top,” “bottom,” “front,” “back,” and “side” are used for purposes of exposition and clarity, such terms are not intended to limit any of the components disclosed herein to a particular orientation or configuration.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. An information handling system comprising:
a circuit board;
a plurality of receptacle connectors electrically coupled to and mechanically mounted upon the circuit board; and
a blocking feature located between a pair of adjacent receptacle connectors of the plurality of receptacle connectors and creating a mechanical interference that prevents insertion of an information handling resource into an empty volume of space between the pair of adjacent receptacle connectors.

2. The information handling system of claim 1, wherein the blocking feature is mechanically coupled to one of the pair of adjacent receptacle connectors.

3. The information handling system of claim 1, wherein the blocking feature is integral to one of the pair of adjacent receptacle connectors.

4. The information handling system of claim 1, wherein the blocking feature has one or more openings formed therein to allow airflow though the blocking feature.

5. The information handling system of claim 1, wherein the blocking feature is formed from a frame comprising the blocking feature and at least one other blocking feature.

6. The information handling system of claim 1, wherein each of the pair of adjacent receptacle connectors is a memory slot configured to receive a memory module.

7. A method comprising:
mechanically mounting a plurality of receptacle connectors upon a circuit board; and
locating a blocking feature between a pair of adjacent receptacle connectors of the plurality of receptacle connectors and creating a mechanical interference that prevents insertion of an information handling resource into an empty volume of space between the pair of adjacent receptacle connectors.

8. The method of claim 7, wherein locating the blocking feature comprises mechanically coupling the locking feature to one of the pair of adjacent receptacle connectors.

9. The method of claim 7, wherein locating the blocking feature comprises forming the locking feature integral to one of the pair of adjacent receptacle connectors.

10. The method of claim 7, further comprising forming one or more openings within the blocking feature to allow airflow though the blocking feature.

11. The method of claim 7, further comprising forming a frame comprising the blocking feature and at least one other blocking feature.

12. The method of claim 7, wherein each of the pair of adjacent receptacle connectors is a memory slot configured to receive a memory module.

13. A receptacle connector comprising:
mechanical features for mechanically retaining an information handling resource within the receptacle connector; and
a blocking feature extending from the mechanical features and configured to, when the receptacle connector is mechanically mounted to a circuit board, create a mechanical interference that prevents insertion of an information handling resource into an empty volume of space between the receptacle connector and an adjacent receptacle connector mechanically mounted to the circuit board.

14. The receptacle connector of claim 13, wherein the blocking feature is mechanically coupled to the mechanical features.

15. The receptacle connector of claim 13, wherein the blocking feature is integral to the mechanical features.

16. The receptacle connector of claim 13, wherein the receptacle connector is a memory slot configured to receive a memory module.
